(19) United States
(12) Patent Application Publication
(10) Pub. No.: US 2005/0183969 A1
(43) Pub. Date: Aug. 25, 2005

(54) Corrosion Monitor

(76) Inventors: Douglas R. Luopa, Amisk (CA); John A. Luopa, Edmonton (CA)

Correspondence Address: EDWARD YOO C/O BENNETT JONES, 1000 ATCO CENTRE, 10035 - 105 STREET, EDMONTON, ALBERTA, AB, T5J3T2, CA

(21) Appl. No.: 10/708,271

(22) Filed: Feb. 20, 2004

(51) Int. Cl. G01N 27/26

(52) U.S. Cl. 205/775.5; 422/53; 204/400

(57) ABSTRACT

A corrosion monitoring system for attachment to a pipe includes a test fluid circuit having a galvanic cell and an ammeter operatively connected to the galvanic cell. The system is configured to attempt to match flow conditions in the galvanic cell as in the pipe.

### BACKGROUND OF INVENTION

The present invention generally relates to a corrosion monitoring system, and more particularly to a system for determining the persistence of a protective corrosion inhibitor film on the inside wall of a conduit such as a pipeline or oil well and downhole tubulars transporting a corrosive fluid.

Corrosion is generally a hidden problem that often cannot be controlled in many industrial settings. In the chemical industry, corrosion activity can limit equipment life and threaten the reliability of industrial installations. Useful materials in process fluids can cause corrosion of the apparatus used to handle such fluids resulting in a need to curtail operations or shut down a processing system. Correcting the effects of corrosion can thus lead to high maintenance costs. Since it is typically not feasible to eliminate corrosion, the effects of corrosion are usually dealt with by removing and replacing the afflicted structure at an estimated stage of corrosion damage.

Similarly, pipelines carry toxic and non-toxic wastes, and storage tanks store high pressure gas and other volatile petroleum products. These pipes, pipelines or tanks are typically made of steel and can have an inside diameter ranging anywhere from two to sixty inches, or even outside of this range. The exterior of these pipes or pipelines is often insulated, and shielded with the insulating and metallic shielding layers being ⅛ to 5 inches or more in thickness, or outside of this range. Moreover, these pipes or pipelines are interconnected by joints, elbow joints, and flanges in complex geometrical layouts.

In conventional petroleum production, crude oil is usually pumped from the formation using oil wells. The crude oil is typically mixed with brine, hydrocarbon gases, carbon dioxide, elemental sulphur and sulphur compounds including hydrogen sulphide, formation sand, dissolved solids, bacteria and their byproducts. This mixture is pumped to treating facilities along underground pipes. After separation, the products are pumped along lengthy pipelines to gathering points.

For a number of reasons, (safety, environmental potential hazards, avoiding costly shut-downs, etc.), the integrity of these pipes or pipelines and oil wells must be preserved. Corrosion and/or defects in the pipe or pipeline and oil wells can occur for a number of reasons. The transported fluid is typically corrosive. In addition, solids can be suspended in the fluid and high velocity flow may cause erosion of the pipeline by the solids. Inspection of the interior of pipelines and oil wells to detect corrosion is difficult and expensive.

If information on the extent of corrosion activity is obtainable before significant damage occurs, remedial measures can be taken to repair process equipment before corrosion leads to equipment failure. Thus, an effective corrosion monitoring program typically begins with obtaining information on the extent of corrosion damage or corrosion activity occurring in a particular installation. With regard to pipeline and oil well corrosion, a variety of different techniques have been used for determining the amount of corrosion damage or corrosion activity that has occurred in a pipeline or oil well used for conveying corrosive fluids.

One method of monitoring corrosion is to insert coupons or probes into the corrosive environment and using either a weight measurement or an electrical resistance measurement to provide an indirect calculation of corrosion. In the first case, the coupon is weighed before and after exposure and an average corrosion rate is calculated from the weight loss the surface area and the time of exposure. For a meaningful determination of corrosion rate the coupon should be exposed for at least 30 days and the coupon must be installed in a location representative of the most severe corrosion in the pipeline. Only flush-mounted coupons come close to being representative of the corrosion rate of the pipeline.

It is also known to use hydrogen probes and external patches. Atomic hydrogen (protons) generated by corrosion readily pass through steel. It has been found that hydrogen probes and external patches are site specific and not suitable for direct determination of corrosion rate but can be used to detect corrosion rate changes.

It is known to use corrosion inhibitor substances which decrease the rate of attack of a corrosive environment on a material such as metal or steel reinforced concrete. Corrosion inhibitors can extend the life of pipelines and oil wells, prevent system shutdowns and failures, and avoid product loss and environmental contamination. The choice of a particular corrosion inhibitor and the frequency and concentration of application is not an exact science. There are methods by which an operator can determine if a corrosion inhibitor is still effective or if it has become ineffective and a maintenance application is required. These methods are not convenient, and may not provide accurate results. As a result, operators will frequently apply inhibitors in significant excess, and waste a significant amount of money to do so.

A coupon comprised of the same steel as the pipeline may be attached to an extractable, adjustable holder which can be screwed into a coupling that is welded to the pipeline. The coupling is usually located in an above-ground, rising section of the pipeline 45 degrees from the bottom centerline where corrosion can be severe due to the higher frequency of gas slugs in this area. The holder is inserted so that the coupon is flush with the inside pipe wall and the flow pattern over the coupon and the pipe wall theoretically match. After an inhibitor batch the coupon is periodically extracted, cleaned with a suitable solvent to remove crude oil and then tested using a copper ion displacement test which highlights steel areas not covered with inhibitor. It has been found that a few hours after a batch of corrosion inhibitor the coupon has no bare steel spots indicating full coverage by the inhibitor. Over time the inhibitor starts to deplete as shown by the gradual increase in the number of bare steel spots. The percentage of remaining inhibitor coverage is at best a subjective estimate. When the coupon is not exactly flush with the inside wall of the pipeline the turbulence created can affect both the amount of inhibitor deposited by the inhibitor batch and the rate of inhibitor depletion. The results are therefore not entirely reliable.

Linear polarization resistance (LPR) probes and instruments measure the ratio of voltage to current. This is accomplished by applying a small voltage, which may range between 10 to 30 mV, to a corroding metal electrode and measuring the corrosion current flowing between the device's anodic and cathodic half cells. The polarization resistance varies inversely with the corrosion rate. LPR probes and instruments require constant submersion in a liquid environment and will not function where a gas phase is constant or periodically present.

Therefore, all existing monitoring methods are believed to have one or more shortcomings. The corrosion rate at a coupon or probe may not be representative of the corrosion rate in the pipeline. The flow pattern over the coupon or probe may not match that of the pipeline. The coupon or probe may not function properly in crude pipelines due to the potential for coating. The coupon or probe may not function in a three-phase flow environment. Interpretation of inhibitor persistence may be subjective. An accelerated test of inhibitor life is typically not possible. Automated documentation of test results may not be available.

It is therefore desirable to provide a reliable method and means for detecting corrosion anywhere in a pipeline or crude oil well or other fluid conduits, which is conveniently connected to a pipe or sections of pipe or crude oil well and can be used under field conditions of high temperature or pressure, or both.

### SUMMARY OF INVENTION

In one aspect, the present invention relates to a corrosion monitoring system for connection to a pipe transporting a fluid or fluid mixture, said system comprising:
(a) a test fluid circuit comprising a galvanic cell comprising an anode, a cathode and an electrical insulator disposed between the anode and cathode;
(b) a pipe connection comprising a draw-off valve for supplying fluid to the test fluid circuits;
(c) a fluid return connection for returning fluid to the pipe at point downstream from the pipe connection;
(d) a pump disposed between the galvanic cell and the fluid return connection, for drawing fluid through the test fluid circuit and returning fluid to the fluid return connection; and
(e) an ammeter operatively connected to the anode and the cathode.

In a preferred embodiment, the system may further comprise a second fluid circuit having an intake located downstream from the pipe connection and upstream from the galvanic cell and an outlet located between the galvanic cell and the pump, and comprising means for measuring flow rate through the second fluid circuit.

In another aspect, the invention may comprise a method of monitoring corrosion or the persistence of a corrosion inhibitor, comprising the steps of:
(a) providing a monitoring system as described herein;
(b) injecting a corrosion inhibitor into the pipe while operating the system pump; and
(c) monitoring or recording a galvanic current between the anode and cathode.

Preferably, the pump is operated at speed such that flow velocity through the test cell is substantially similar to flow velocity through the pipe. As well, it is preferred to allow the fluid to flow through the test cell prior to application of the inhibitor.

### BRIEF DESCRIPTION OF DRAWINGS

The invention will now be described by way of an exemplary embodiment with reference to the accompanying simplified, diagrammatic, not-to-scale drawings. In the drawings,

FIG. 1 is a schematic representation of one embodiment of the present invention.

FIG. 2 is a graphical representation of relative corrosion rate versus time, as measured by an apparatus of the present invention.

### DETAILED DESCRIPTION

The present invention provides for methods and systems for monitoring corrosion or the life of corrosion inhibitors, or both, in a flowing system. When describing the present invention, all terms not defined herein have their common art-recognized meanings.

In general terms, the invention comprises a galvanic anode and cathode pair of pipe elements forming a galvanic cell. Galvanic element pairs comprise two dissimilar metals immersed in an electrolyte to be monitored. This dissimilarity produces a natural current flow through the electrolyte. The elements, or electrodes, are attached through a low resistance ammeter and the resulting coupling current offers insight into the corrosion rate of the metal anode. The use of a galvanic cell is particularly suitable to a method of monitoring the persistence of a corrosion inhibiting film. Because no external voltage is applied, no irreversible changes are made to the metal/film interface by polarization of the probes away from their natural state.

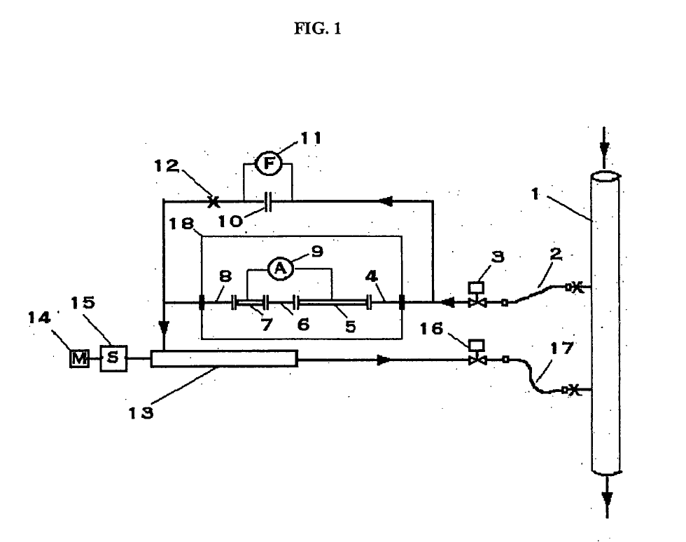

With reference to FIG. 1, the apparatus is attached to the pipe (1) which transports the corrosive fluid to be tested. The hose and valve (2) draw a fluid stream from the pipe (1) which then passes through the inlet emergency shutoff valve (3). The fluid withdrawal valve (2) is preferably located so that a representative sample of the fluid in the pipe is obtained. In one embodiment, a first portion of the flow is directed towards the galvanic cell (18) or test cell. The first portion of the cell (18) comprises an insulating spool (4) which electrically insulates the cell (18) from the pipe (1). Another insulating spool (6) separates the cathode (5) from the anode (7), followed by another insulating spool (8). It is of course essential that the anode and cathode be electrically isolated from each other and that the test cell (18) be electrically isolated from the pipe (1) and the remainder of the apparatus. Non-conducting hoses or spool materials may be used.

The flow from the galvanic cell (18) then rejoins the flow from the second portion of the flow. The natural galvanic current between the cathode (5) and the anode (7) is measured and recorded by the ammeter/data logger (9). The fluid which passes through the cell acts as an electrolytic solution. If the anode (7) and cathode (5) are comprised of dissimilar metals and are exposed to the electrolyte, then a small amount of galvanic current will be generated in accordance with the electrochemical potential between the anode and cathode. If, however, the anode (7) is coated with a corrosion inhibitor, which blocks contact with the electrolyte, then the current is substantially reduced.

The anode and cathode may be comprised of any suitable redox pair of metals, which are well known in the art. The cathode must of course be higher on the electromotive series (less readily oxidized) than the anode. In one embodiment, the anode is comprised of carbon steel and the cathode is comprised of steel with high nickel content, such as a stainless steel. Preferably, but not necessarily, the anode is comprised of the same alloy as the pipeline or oil well tubulars being monitored. This identicality ensures that the affinity and interaction between the corrosion inhibitor and the pipe substrate is identical in the test cell as it is in the pipe or tubing. Conventionally, pipe and tubing comprises A105 or A106 carbon steel. The cathode may be comprised of an alloy having a high nickel content, such as 316 stainless steel. The nickel content of the stainless steel acts as the oxidant in the redox pair while the iron in the carbon steel acts as the reductant.

In order to promote a fully developed flow profile, the anode (7), cathode (5) and insulating spools (4, 6, 8) are preferably all manufactured with the same internal diameter. In a preferred embodiment, there should be sufficient length of straight pipe upstream and downstream of the measuring cell (18) to ensure relatively swirl-free flow through the cell (18). Preferably, in one embodiment, there is a length of straight pipe which is equal to about 15 times the inner diameter of the pipe upstream and about 10 times the diameter downstream of the measuring cell (18).

In one embodiment, it is preferred that the cathode (5) have a larger surface area exposed to the fluid than the anode (7). Because it is desirable to maintain a constant inner diameter through the cell, it is preferred to provide a longer cathode section compared to the anode section. Preferably, the cathode surface area is about 1.5 times larger than the anode and more preferably it is about 3 times larger than the anode. Because the anode and cathode are tubular components with identical internal diameters in the embodiment described herein, the surface area of each will be a function of the length of each of the anode and cathode.

As shown in FIG. 1, the cathode (5) is upstream from the anode (7). However, in another embodiment, the anode may be upstream from the cathode.

In one embodiment, a second flow measuring circuit is provided which splits the flow diverted from the pipe (1). This is desirable to allow adjustment of the flow through the test cell without adjusting the pump speed. Flow rate through the test cell may be decreased by increasing flow through the second circuit by opening globe valve (12). Conversely, closing globe valve (12) will decrease flow through the second circuit and increase flow through the test cell. The second circuit includes a flow measuring orifice (10) across which a differential pressure transmitter (11) is connected to measure and indicate the flow rate through the orifice (10). Alternative and well-known methods of measuring flow rate may be utilized.

The recombined flow from the branches then enters the suction of pump (13), which may preferably be a positive displacement type pump. It is preferred to place the pump downstream of the galvanic cell (18) so that pump-induced swirl does not disrupt the flow profile in the cell (18). The discharge of pump (13) flows through an outlet emergency shutoff valve (16), then through the outlet valve and hose (17) and back to pipe (1). It is preferable that the pump be able to handle three-phase flow, which permits operation where gases and solids are prevalent and which also permits more accurate comparison between the test cell and the pipe (1). As may be appreciated, gas slugs may have a significant impact on corrosion rates and the formation and persistence of inhibitor matrices in a pipe.

An electric motor (14) or other suitable drive means drives the positive displacement pump (13). The pump speed may be adjusted through an adjustable speed reducer (15). The flow through the device, including the measuring cell (18), may be controlled by adjusting the speed of the positive displacement pump (13). The flow though the measuring cell (18) is equal to the total flow generated by the pump (13) less the flow measured by orifice (10) and transmitter (11) in the second circuit. The total flow through the pump (13), and therefore through the apparatus, is correlated to the rotational speed and known output of the pump. It may be desirable, but not necessary, to provide a flow measuring device with the apparatus to measure total flow.

The ammeter/logger (9) records changes in the naturally-induced galvanic current between the anode and cathode during corrosion inhibitor life tests. The methods of the present invention permit detection of when the batched inhibitor has filmed the anode, when a protective matrix has formed on the interior surface of the anode, and when the protective matrix has started depleting at the end of the inhibitor's protective life.

In operation, it is preferred to clean and rinse with a suitable solvent at least the anode portion of the cell, and preferably the entire cell before a test run. Before inhibitor batching, it is preferred to maintain the flow velocity through the measuring cell to match the pipeline to allow the anode to pre-corrode. During inhibitor batching it is preferred to maintain this matching flow velocity so that the inhibitor residence time is substantially the same in the cell as it is in the pipeline or crude oil well. Furthermore, it is preferred to match the flow velocities during formation of the protective matrix so that the thickness and structure of the matrix is the same in the cell as it is in the pipeline or crude oil well. After the matrix has formed, as indicated by a steady low galvanic current, depletion of the inhibitor film may be accelerated by increasing the flow through the measuring cell.

The ammeter/logger (9) provides an objective record of the inhibitor life test. It may be objectively determined by a rise in galvanic current from the measuring cell that the inhibitor coating has been removed or is being depleted.

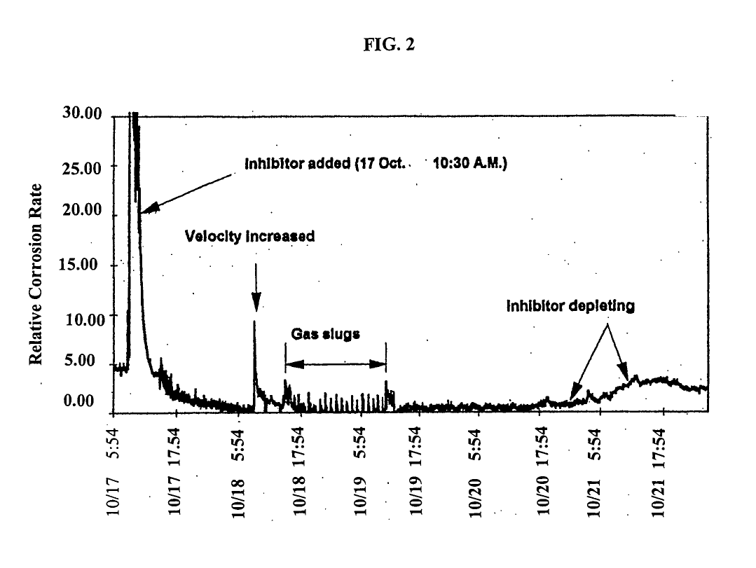

The inhibitor film life in the pipe (1) can be accurately determined from the life in the measuring cell through the use of field-verified correlations based on the pipeline diameters and velocities (Wang et al. NACE International Paper 02501 presented at CORROSION 2002). FIG. 2 shows graphical results of a test run using an apparatus as described herein. As may be seen, the baseline corrosion rate is about 5.0 on a relative scale. This measure is directly related to the galvanic current measured by the test cell. Immediately upon addition of an inhibitor, the rate increases and decreases dramatically, eventually reaching near-zero corrosion within 24 hours of the addition of the inhibitor. An increase in fluid velocity produced a short spike as did the passing of gas slugs through the test cell. Eventually, as the inhibitor depleted, the corrosion rate gradually increased closer to the baseline rate.

The present invention also allows testing the effectiveness of continuously injected inhibitor, as opposed to batch application, by measuring the corrosion rate when the inhibitor is injected. Thus, it maybe possible to optimize the inhibitor injection rate because the measured corrosion rate will vary with the injection rate.

As will be apparent to those skilled in the art, various modifications, adaptations and variations of the foregoing specific disclosure can be made without departing from the scope of the invention claimed herein. The various features and elements of the described invention may be combined in a manner different from the combinations described or claimed herein, without departing from the scope of the invention.

1. A corrosion monitoring system for connection to a pipe transporting a fluid or fluid mixture, said system comprising:
(a) a test fluid circuit comprising a galvanic cell comprising an anode, a cathode and an electrical insulator disposed between the anode and cathode;
(b) a pipe connection comprising a draw-off valve for supplying fluid to the test fluid circuits;
(c) a fluid return connection for returning fluid to the pipe at point downstream from the pipe connection;
(d) a pump disposed between the galvanic cell and the fluid return connection, for drawing fluid through the test fluid circuit and returning fluid to the fluid return connection; and
(e) an ammeter operatively connected to the anode and the cathode.

2. The system of claim 1 further comprising a second fluid circuit having an intake located downstream from the pipe connection and upstream from the galvanic cell and an outlet located between the galvanic cell and the pump, and comprising means for measuring flow rate through the second fluid circuit.

3. The system of claim 1 wherein the galvanic cell is preceded by a length of substantially straight pipe equal to at least about 10 times the inner diameter of the cell.

4. The system of claim 3 wherein the galvanic cell is preceded by a length of substantially straight pipe equal to at least about 15 times the inner diameter of the cell.

5. The system of claim 3 wherein the galvanic cell is succeeded by a length of substantially straight pipe equal to at least about 5 times the inner diameter of the cell.

6. The system of claim 5 wherein the galvanic cell is succeeded by a length of substantially straight pipe equal to at least about 10 times the inner diameter of the cell.

7. The system of claim 1 wherein the anode is comprised of a substantially similar metal or alloy as that of the pipe.

8. The system of claim 7 wherein the cathode comprises nickel.

9. The system of claim 8 wherein the cathode comprises stainless steel or nickel-plated ferrous pipe.

10. The system of claim 7 wherein the cathode is comprised of a metal lower on the electromotive series than the anode.

11. The system of claim 1 wherein the cathode presents a larger surface area to the fluid than the anode.

12. The system of claim 11 herein the ratio of the surface area of the cathode to the surface area of the anode is at least about 1.5.

13. The system of claim 12 wherein the ratio is about 3.

14. The system of claim 1 wherein the cathode is downstream from the anode.

15. The system of claim 1 wherein the anode is downstream from the cathode.

16. A method of monitoring corrosion or the persistence of a corrosion inhibitor, comprising the steps of:
(a) providing a system as claimed in any one of claims 1 to 15;
(b) injecting a corrosion inhibitor into the pipe while operating the system pump; and
(c) monitoring or recording a galvanic current between the anode and cathode.

17. The method of claim 15 wherein the pump is operated at speed such that flow velocity through the test cell is substantially similar to flow velocity through the pipe.

18. The method of claim 16 wherein the fluid is allowed to flow through the test cell prior to application of the inhibitor.
